(19) United States
(12) Patent Application Publication
(10) Pub. No.: US 2011/0062842 A1
(43) Pub. Date: Mar. 17, 2011

(54) FURNITURE DRIVE

(76) Inventors: Edgar HUBER, Hard (AT); Gerald FRIESENECKER, Lauterach (AT)

(21) Appl. No.: 12/940,427

(22) Filed: Nov. 5, 2010

Related U.S. Application Data
(63) Continuation of application No. PCT/AT2009/000157, filed on Apr. 20, 2009.

(30) Foreign Application Priority Data
May 15, 2008 (AT) A 776/2008

(51) Int. Cl. A47B 88/00; H02K 7/116; H02K 7/14

(52) U.S. Cl. 312/319.5; 310/83

(57) ABSTRACT

The invention relates to a furniture drive for driving a movable piece of furniture, comprising an electric motor, an actuator that can be moved back and forth between two end positions to apply a force on the piece of furniture to be driven, and a gearbox connected between the electric motor and actuator, the gearbox having at least one gear stage that is configured as an eccentric gearbox and comprising two gear wheels that mesh with each other, characterized in that one of the two gear wheels (7, 8) is firmly connected or coupled to the actuator (4) and the other gear wheel (7, 8) is coupled to the electric motor (3) such that the eccentric gearbox (6) has two limit positions, which correspond to the end positions of the actuator (4), and upon a rotation of the gear wheels (7, 8), starting from a first of the two limit positions to the other limit position, the gear ratio decreases steadily.

The present invention concerns a furniture drive for driving a movable furniture part comprising an electric motor, an actuator reciprocatable between two end positions to apply force to the furniture part to be driven, and a transmission connected between the electric motor and the actuator, wherein the transmission has at least one transmission stage in the form of an eccentric transmission with two mutually meshing gears.

For various reasons (lower procurement costs, amount of space required, power requirement) it is desirable to use an electric motor which is as small as possible and which in addition is intended to advantageously manage without a complicated electronic regulating system for torque regulation.

Austrian patent application No A 1542/2007 of earlier priority to the present applicant discloses a furniture drive having a varying transmission ratio which is achieved by an elbow lever arrangement.

EP 1 194 708 B1 describes a drive apparatus for driving an actuator with a transmission stage in the form of an eccentric transmission, the eccentric transmission having two mutually meshing gears. That specification teaches that in many situations of use for transmissions, a maximum drive output torque is required only in one position, in which respect such requirements are said to occur for example in relation to transmissions which perform a closing function.

In accordance with that specification, a drive by way of an electric motor and a transmission with a constant transmission ratio suffers from the disadvantage that the level of the transmission ratio on the one hand must be so high that the maximum torque can be achieved with the electric motor used, which generally requires a high transmission ratio. On the other hand a high transmission ratio is said to also signify a long setting time for the transmission.

Instead of a transmission with a constant transmission ratio EP 1 194 708 B1 proposes a two-stage transmission, the first transmission stage being in the form of a wave transmission (harmonic drive transmission) and the second stage being in the form of an eccentric transmission.

This specification does not teach specific examples of advantageous transmission ratio configurations. Particular attention is directed to the interplay between torque and setting time.

EP 1 194 708 B1 is of only very limited significance by virtue of its fixation with the ratio between torque and setting time in situations of use where that ratio plays only a very subordinate part.

EP 1 898 036 A1 discloses an operating actuator for a vehicle flap provided with an eccentric transmission having two mutually meshing gears. That specification teaches that, in relation to motor vehicle flaps, it is necessary to act on the motor vehicle flap with a sufficiently high torque to overcome the reaction forces caused by a seal during the closing process. That is resolved in such a way that the vehicle flap is actuated by way of a comparatively low transmission ratio during the predominant part of the closing movement. When the motor vehicle flap is approaching the closed position and in particular when it is pressed against a seal, it is driven at a higher transmission ratio.

The opening movement is not discussed in EP 1 898 036 A1, which is to be attributed to the fact that vehicle flaps are mostly opened manually.

Therefore EP 1 898 036 A1 is not relevant in relation to a furniture drive of the general kind set forth, having an actuator which is reciprocated between two end positions.

DE 197 39 851 A1 represents an even more remote state of the art. That specification teaches a windscreen wiper apparatus with two windscreen wiper levers which are driven by a single electric motor, wherein there is provided an eccentric transmission for producing a retardation or an acceleration of the reciprocating movement of the windscreen wiper levers in predetermined regions.

The object of the invention is to provide a furniture drive which using a per se known eccentric transmission has a more advantageous operating characteristic than those furniture drives in which the transmission ratio is constant over the entire course of movement of the movable furniture part.

The invention attains that object by a furniture drive having the features of claim 1.

The fixed connection of one of the two gears of the eccentric transmission to the actuator and the fact that the two gears of the eccentric transmission mesh with each other ensures that there is a 1:1 correspondence between the position of the actuator and the relative position of the two gears of the eccentric transmission. In particular as a result the eccentric transmission has two end positions corresponding to those of the actuator. That measure further makes it possible to provide that the transmission ratio continuously decreases upon a rotation of the gears of the eccentric transmission starting from a first of the two end positions towards the other end position.

In the furniture drive according to the invention therefore it is provided that the torque exerted by the electric motor on the actuator by way of the transmission starting from the first end position of the eccentric transmission and by way of the above-discussed correspondence is thus also greatest in the region of the corresponding end position of the actuator. In the mounted condition of the furniture drive on or in a furniture carcass, with the actuator being connected to the furniture part to be driven, the end positions of the actuator correspond to a closed or entirely opened position respectively of the furniture part to be driven. In accordance with the invention therefore when starting from the first end position (closed position of the furniture part), when the electric motor first starts slowly, a particularly high and therefore optimum level of torque is available.

In the preferred embodiment the furniture part is a flap which can be more easily set in motion from the opened end position due to the support of the force of gravity and the absence of a force storage means that is to be loaded up of an automatic pull-in mechanism. Starting from the closed position the flap can be more easily set in motion by the measure according to the invention as here the maximum torque is available.

It is to be noted that the fixed connection or coupling of one of the two gears of the eccentric transmission to the actuator can naturally be releasable in itself in order for example to facilitate mounting of the furniture drive or to replace parts. The only essential point is that, during operation of the furniture drive, it is possible to ensure a correspondence between the end positions of the actuator and the end positions of the eccentric transmission by virtue of the connection or coupling.

Further advantageous embodiments of the invention are defined in the appendant claims.

Protection is also requested for an article of furniture having a movably mounted furniture part (for example flap, door or drawer) having a furniture drive according to the invention.

Further advantages and details of the invention will be apparent from the Figures and the related specific description. In the drawing:

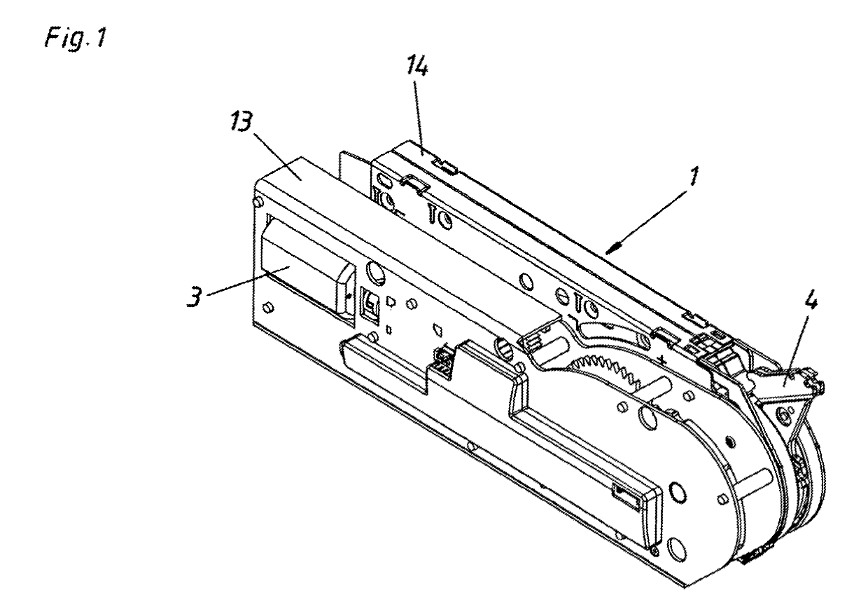

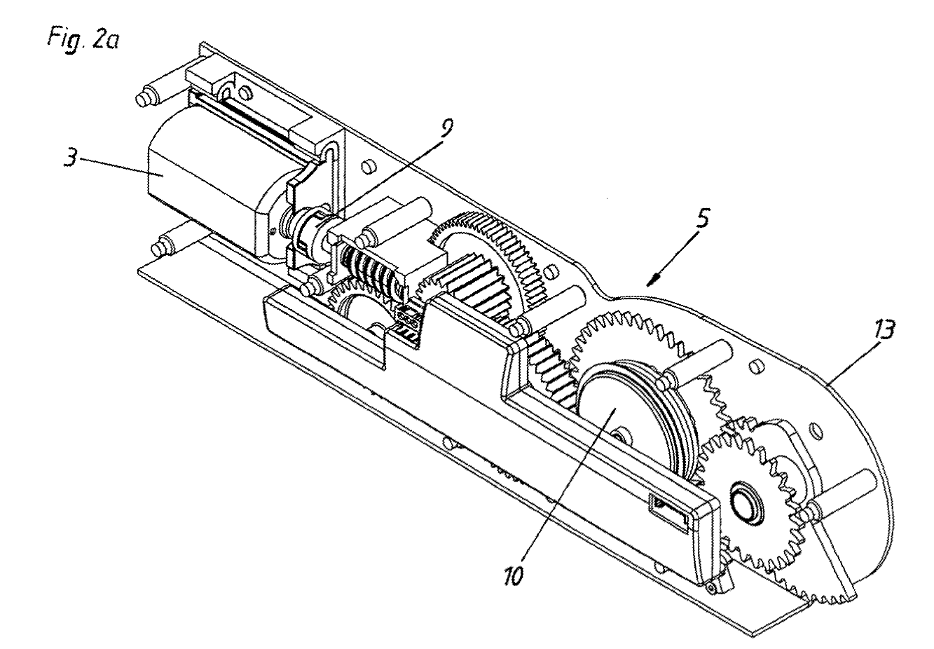

FIG. 1 shows a perspective view of a furniture drive according to the invention,

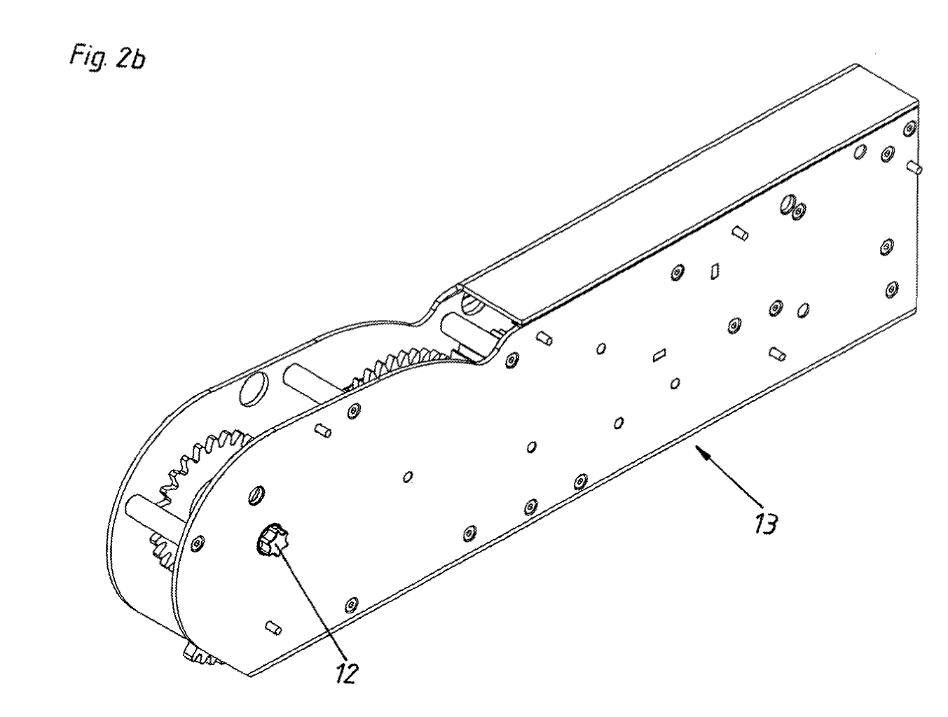

FIGS. 2a and 2b show the line of drive force between the electric motor and the actuator of the furniture drive shown in FIG. 1 as a perspective view from the front and from the rear respectively,

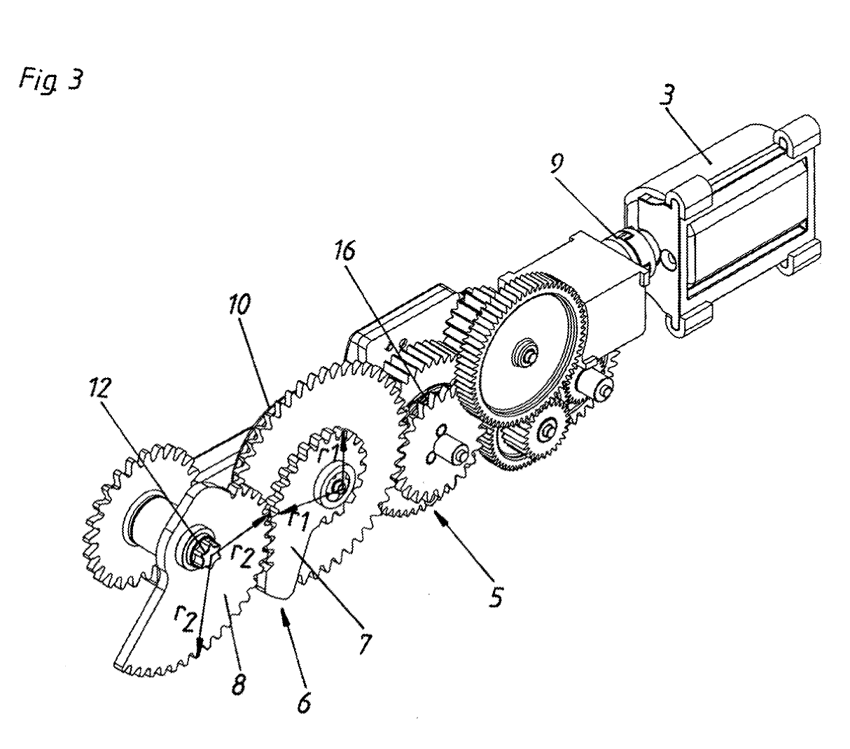

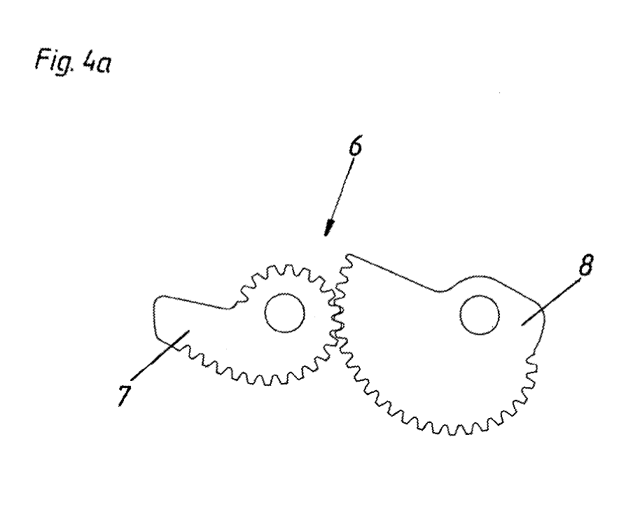

FIG. 3 shows a view corresponding to FIGS. 2a and 2b, but in which the view of all components not directly belonging to the drive line has been omitted,

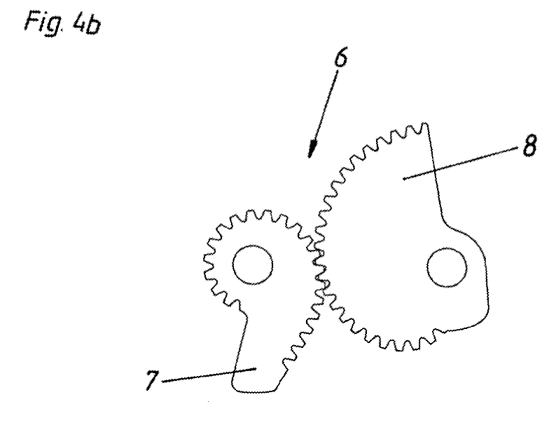

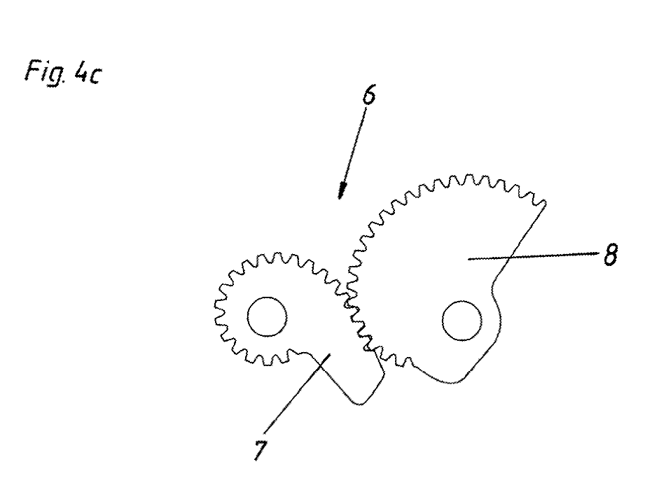

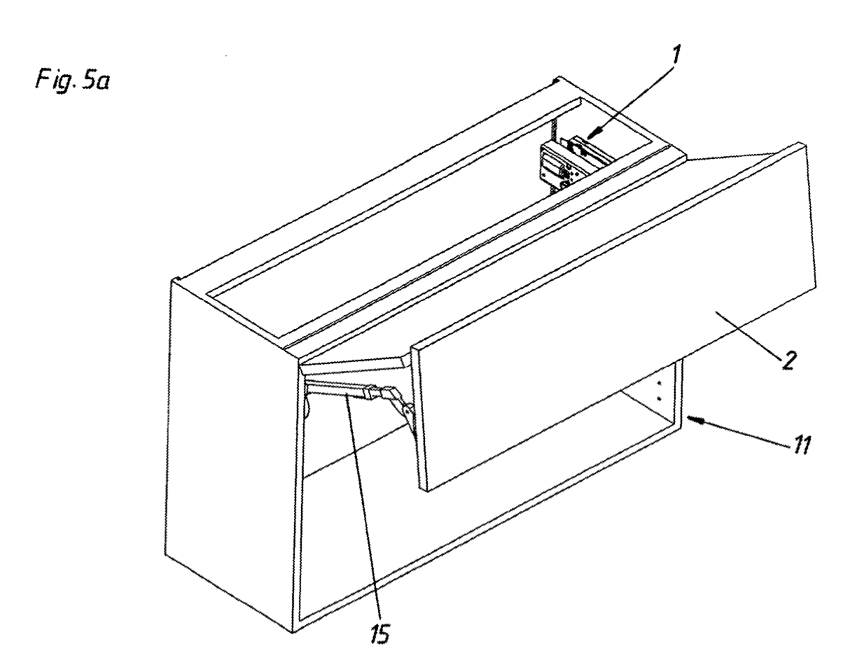

FIGS. 4a-4c show an eccentric transmission which can be used in a furniture drive according to the invention in three different positions, and

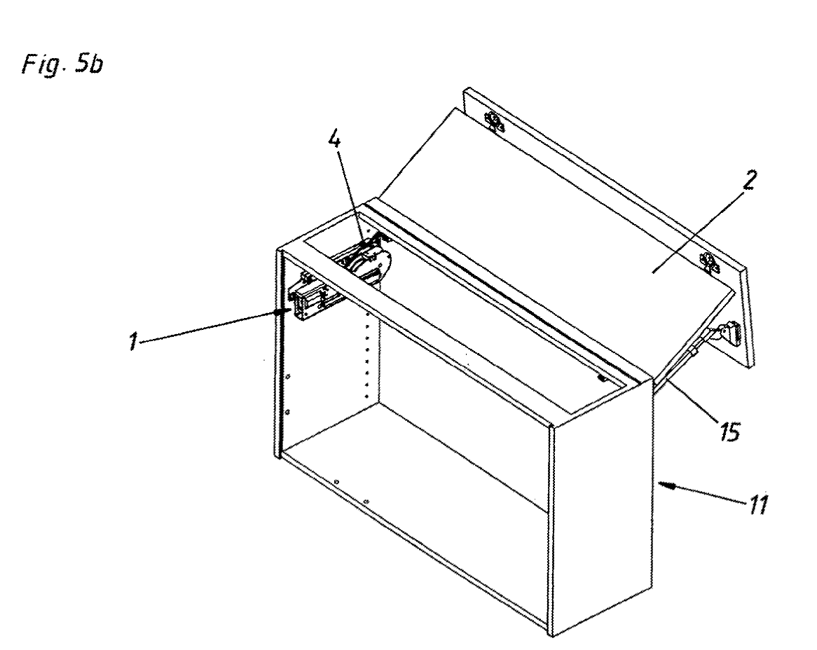

FIGS. 5a and 5b show the furniture drive according to the invention in the mounted condition in a furniture carcass.

In this embodiment the furniture drive 1 shown in FIG. 1 comprises two releasably connected units 13, 14. In that respect the unit 14 represents an actuating drive which in itself is fully functional for a furniture flap, as is known per se so that it does not have to be described in greater detail herein. Particular attention is only to be directed to the actuator 4 which is arranged here in the region of the unit 14 and by way of which force is applied to the movable furniture part 2 by way of a lever mechanism 15 (see FIG. 5).

The electric motor 3, the transmission 5 and a shaft 12 non-rotatably connected to the actuator 4 are arranged in the unit 13 which is described in greater detail in the following Figures.

FIGS. 2a and 2b show the unit 13 with the unit 14 removed. The force transmission interface between the two units 13 and 14 is represented in this case by the shaft 12 which is drivable by the electric motor 3 by way of the transmission 5 and which is of a profiled configuration and which engages into a recess of corresponding configuration connected to the actuator 4. When the shaft 12 rotates the actuator 4 is also correspondingly rotated.

The drive train (see FIG. 2a) of the furniture drive 1 according to the invention begins at the left in FIG. 2a with the electric motor 3 which co-operates by way of a worm drive with a first transmission stage of the transmission 5. In this case, arranged between the electric motor 3 and the transmission 5 is a dog clutch 9 which serves for sound decoupling and to compensate for axial misalignments. In this embodiment the transmission 5 further has an overload safety device 10 which is intended to prevent damage to the electric motor 3 due to an excessive force being applied to the actuator 4. A freewheel coupling 16 permits the movement of the furniture part 2 over a defined range (for example shortly before the closed position of the furniture part 2) without impediment by the electric motor 3. In that way it is possible in that region to achieve a preferred sequence of movements for the furniture part 2 by purely mechanical components (for example pull-in device), instead of having to regulate the electric motor 3 by way of a regulating system for that purpose.

Now, the gears 7, 8 of the transmission stage which is in the form of an eccentric transmission 6, as can be particularly clearly seen in FIG. 3, are of particular interest. The Figure shows two different radii r1, r2, wherein the radii r1 relate to the gear 7 and the radii r2 relate to the gear 8. It is now of significance that the respective radii r1, r2 (respectively measured from the respective axis of rotation of the gear to the gear rim) alter in a predefined fashion in such a way as to give the desired torque configuration. As in this case the axes of rotation of the two gears 7, 8 are arranged at a fixed spacing relative to each other, here the radius r1 of the gear 7 coupled to the electric motor 3 and the radius r2 of the gear 8 connected to the actuator 4 must respectively change in such a way that in total that gives precisely the spacing between the two axes of rotation.

FIGS. 4a-4c show an eccentric transmission 6 which can be used according to the invention and which in this specific embodiment differs somewhat from the eccentric transmission 6 shown in FIGS. 1-3. This difference however only concerns the configuration of the gears 7, 8 in a region away from the gear rim and is therefore irrelevant for the mode of operation according to the invention.

The end positions of the eccentric transmission 6, shown in FIGS. 4a and 4c respectively, correspond to a closed end position (FIG. 4a) of the furniture part 2 and a fully opened end position (FIG. 4c) of the movable furniture part 2 respectively. The position in FIG. 4b corresponds to an intermediate position of the movable furniture part 2. It is now of significance that the transmission ratio of the eccentric transmission and thus the entire transmission 5 continuously decreases upon a rotary movement of the gears 7, 8 starting from the first end position in FIG. 4a towards the other end position (FIG. 4c). The transmission ratio is thus at a minimum value at the other end position (this being equivalent to a minimum torque of the gear 8 operating as the drive output gear and a maximum peripheral speed of the gear 8).

Depending on the respective position of the two gears 7, 8 relative to each other, there are different effective lever lengths for force transmission and thus the desired different levels of torque.

FIGS. 5a and 5b respectively show a front view and a rear view of an article of furniture 11, a furniture drive 1 according to the invention having been mounted at the left-hand side of the furniture carcass. In this case the actuator 4 of the furniture drive 1 is connected by way of a lever mechanism 15 to the furniture part 2 to be driven. In the illustrated embodiment a furniture drive 1 according to the invention is provided only at one side of the furniture carcass while only the mechanical unit 14 is arranged on the other side. It will be appreciated that it would also be possible to envisage the provision of units 13 and thus complete furniture drives 1 according to the invention, at both sides of the furniture carcass.

Triggering of this furniture drive 1 according to the invention can be implemented in per se known manner by way of a touch-latch functionality. With that functionality, a slight movement, caused by the user, of the movable furniture part 2 (for example by being pushed in or pulled) is detected by a sensor and consequently the activation command is given to the furniture drive 1. That is effected by a control or regulating unit, that is already known per se, for the furniture drive 1, which can be integrated in the furniture drive 1 itself.

All representations in the Figures are to scale and with correct angles.

1. A furniture drive for driving a movable furniture part; comprising: an electric motor, an actuator reciprocatable between two end positions to apply force to the furniture part to be driven, and a transmission connected between the electric motor and the actuator, wherein the transmission has at least one transmission stage in the form of an eccentric transmission with two mutually meshing gears, wherein one of the two gears is fixedly connected or coupled to the actuator and the other gear is coupled to the electric motor so that the eccentric transmission has two end positions corresponding to the end positions of the actuator and the transmission ratio continuously decreases upon a rotation of the gears starting from a first of the two end positions towards the other end position.

2. A furniture drive as set forth in claim 1 wherein the axes of rotation of the two gears of the eccentric transmission are arranged at a fixed spacing relative to each other.

3. A furniture drive as set forth in claim 2 wherein the radius of the gear coupled to the electric motor increases starting from the first end position towards the other end position and the radius of the gear connected or coupled to the actuator correspondingly decreases.

4. A furniture drive as set forth in claim 1 wherein at least one of a freewheel coupling and an overload safety device is or are connected between the gear coupled to the electric motor and the electric motor.

5. A furniture drive as set forth in claim 1 wherein the actuator is drivable by the gear by way of a shaft non-rotatably connected to the gear.

6. An article of furniture comprising a movably mounted furniture part, comprising a furniture drive as set forth in claim 1.

7. An article of furniture as set forth in claim 6 wherein the furniture part is in the form of a flap, door or drawer.

8. An article of furniture as set forth in claim 6 wherein the first end position corresponds to that end position of the actuator at which the movably mounted furniture part is in its closed position.
